(19) United States
(12) Patent Application Publication
(10) Pub. No.: US 2025/0085691 A1
(43) Pub. Date: Mar. 13, 2025

(54) SYSTEM AND METHOD FOR AI-GENERATED PATTERNS INTEGRATING MULTI-FOOD MATERIAL EXTRUSION, 3D PRINTING, AND LASER APPLICATIONS

(71) Applicant: The Hong Kong University of Science and Technology, Hong Kong (CN)

(72) Inventors: Guijun LI, Hong Kong (CN); Kong Wai LEE, Hong Kong (CN); Yang XU, Hong Kong (CN); Yee Him Timothy CHAN, Hong Kong (CN); Miao TANG, Hong Kong (CN); Huan LIU, Hong Kong (CN); Yexin PAN, Hong Kong (CN); Qiaoyaxiao YUAN, Hong Kong (CN)

(21) Appl. No.: 18/818,665

(22) Filed: Aug. 29, 2024

Related U.S. Application Data
(60) Provisional application No. 63/581,985, filed on Sep. 12, 2023.
(60) Provisional application No. 63/588,003, filed on Oct. 5, 2023.

(51) Int. Cl. G05B 19/4099

(52) U.S. Cl. CPC G05B 19/4099; G05B 2219/32128; G05B 2219/33002; G05B 2219/35134; G05B 2219/49023

(57) ABSTRACT

A method using AI models to generate patterns or images on a pastry is provided. The method at least includes steps as follows: providing a UI module for user input of keywords and descriptions; generating black and white vector-style images based on this input using an AI-based image module; processing the 2D image into digital instructions via an image-transformer module; sending these instructions to a laser patterning module; and using the laser patterning module to apply the pattern to the cookie's surface.

### TECHNICAL FIELD

The present invention generally relates to artificial intelligence (AI) models for generating customized patterns on manufactured food; and in particular to systems and methods for AI-generated patterns integrating multi-food material extrusion, 3D printing, and laser applications.

### BACKGROUND

Under the guidance of automation technology, some traditional handmade food industries are beginning to shift towards the trend of using machines to produce desserts entirely. Among these traditional handmade foods, cookies and mooncakes have the potential for automated production because, in addition to the food itself, they require additional decorations or patterns.

For cookies, prior art in the field of cookie decoration primarily revolved around manual techniques that have been practiced for generations. These traditional methods involve skilled artisans using tools like piping bags, brushes, and stencils to create patterns on cookies. However, these techniques suffer from several limitations that hinder overall efficiency and variety of designs.

Firstly, manual techniques are time-consuming and labor-intensive. Secondly, the range of available designs is often limited to traditional methods. Artisans may have a repertoire of patterns they can create, but these are often predetermined or repeated, resulting in a lack of uniqueness and personalization. Customers seeking customized designs or specific themes may find it difficult to fulfill their requirements using manual techniques alone. In addition to traditional manual techniques, the market offers pre-set pattern scanning machines for cookie decoration. These machines utilize a mechanical system to automate the process of decorating cookies with predetermined patterns or images. Instead of manually piping or drawing on each cookie, these machines can engrave the desired design onto the surface of the cookie. One common approach used in some of these machines involves the use of ink as an additive for creating the desired patterns. The machine is equipped with an inkjet system that deposits edible ink onto the cookies to form the desired designs. While this method offers automation and precise pattern replication, it also has some disadvantages. One significant disadvantage of using ink as an additive is the potential impact on taste and texture. The ink can alter the flavor and mouthfeel of the cookie, especially if the ink has a strong or artificial taste. It may detract from the overall quality and enjoyment of the cookie, particularly for those who prefer a more traditional or natural taste.

Another main drawback of pre-set pattern scanning machines is the lack of customization. These machines typically come with a limited selection of predetermined patterns or images that users can choose from. While this may suffice for some basic designs, it severely restricts the creative potential and uniqueness of the decorated cookies. Customers looking for personalized or intricate designs may find themselves limited by the available options. Furthermore, the pre-set patterns on these machines are often fixed and cannot be easily modified or customized by the user. This limits the flexibility and adaptability of the machine to cater to individual preferences or specific themes. As a result, the range of designs that can be achieved with these machines remains limited and repetitive.

Furthermore, in the prior art, there is a lack of user-friendly methods that eliminate the need for manual drawing or designing skills. With conventional techniques and pre-set pattern scanning machines, users often have to rely on their own artistic abilities or pre-existing patterns to create designs on cookies.

Similarly, the traditional mooncake-making process involves many labor-intensive steps. First, the dough and filling ingredients are prepared separately. The dough is typically made from flour, water, and other additives, while the filling can vary depending on regional preferences but often includes ingredients like lotus seed paste, red bean paste, or salted egg yolks. The dough is then wrapped around the filling, forming a ball-shaped pastry. The pastry ball is placed into a mold, typically made of wood or plastic, to achieve the desired shape and appearance. The mold is pressed firmly, imprinting a pattern onto the surface of the mooncake. Afterward, the molded mooncakes are baked in an oven until they achieve a golden-brown color. This traditional mooncake production method poses limitations in consistency and customization. Manually molding each mooncake requires skilled labor and is susceptible to variations in shape and pattern. Moreover, the available patterns are limited to the designs provided by the molds, restricting creativity and personalization options for mooncake producers.

When it comes to 3D food printing, including the printing of mooncakes, there are specific challenges related to the food 3D design process and the use of multiple ingredients. First, meal preparation for 3D printing often requires technical skills in computer 3D modeling, which can act as a barrier for individuals who wish to create their customized food shapes and appearances. The second significant issue is the printability of different materials with varying properties. Each ingredient may have distinct viscosity, flow characteristics, and temperature requirements, making it difficult to extrude them consistently through a single printing nozzle. Switching between syringes or printing nozzles to accommodate various ingredients is time-consuming and inefficient. It interrupts the printing workflow and prolongs the overall production time, which may further increase the risk of food contamination from the environment. While dual-material printing technologies are available in the market, they are generally limited to printing with only two materials, which falls short when multiple ingredients must be embedded in a single food item.

These limitations in the computerized food design process and nozzle switching present challenges in achieving precise control over the printing of mooncakes with multiple ingredients. The existing methods do not provide an efficient and seamless solution for printing intricate patterns and designs while incorporating various ingredients.

Based on the above, integrating traditional handmade foods with current technology has become a significant challenge.

### SUMMARY OF INVENTION

It is an objective of the present invention to provide systems and methods to address the aforementioned shortcomings and unmet needs in the state of the art.

One of the solutions provided by the present invention addresses the limitations of traditional mooncake production by introducing an AI-generated extrusion pattern for 3D printing on fortified mooncakes. AI algorithms enable the generation of unique and customizable designs, providing mass customization capabilities for mooncakes. Individuals can create their personalized food shapes and appearances by simplifying the creation process and reducing the technical expertise required. This customization extends beyond aesthetics, as the 3D food printing technology enables the precise dosage and calculation of nutrients, fibers, and even traditional Chinese medicinal herbal ingredients.

The present invention incorporates artificial intelligence (AI) to simplify the creation process and reduce the technical expertise required. By leveraging well-established AI text-to-image or image-to-image models implemented in Python-based software, the invention enables users to input positive and negative keywords that define the desired aesthetics and characteristics of the food shape. These keywords act as criteria for the AI algorithm to generate black-and-white vector-style images, which can be directly converted into a G-code file for laser patterning or further extruded into three-dimensional patterns suitable for 3D printing.

The generated two-dimensional patterns can be further processed to enable 3D printing extrusion by determining the desired volume with millimeter resolution and then slicing it into G-code instructions. G-code is a standard programming language used in 3D printing that defines the specific movements and actions of the printer, including the extrusion path and the layering of the printed material. The precise generation of G-code is crucial for achieving accurate and consistent 3D food prints.

Furthermore, the invention incorporates a real-time 4-nozzle material switching mode with independent air pressure valves, allowing for the mixing and division of different layers with distinct food ingredients of unique viscosity and rheological properties based on the generated extrusion pattern. This enables the creation of visually appealing and customized mooncakes with varying flavors and textures, overcoming the limitations of current 3D printing technologies.

The proposed invention revolutionizes mooncake production by offering consistency, mass customization, and the ability to embed multiple ingredients. It allows individuals to explore new flavors, designs, and nutritional compositions while promoting healthier eating habits. Additionally, integrating AI, 3D printing, and laser patterning of food technology has broader applications in the culinary world.

One of the solutions provided by the present invention is to improve the traditional mooncake production process by combining AI, advanced 3D printing techniques, and a focus on personalized nutrition. It streamlines the workflow, enhances customization options, and allows for the creation of intricate mooncake designs with fortified ingredients.

Furthermore, by incorporating multi-nozzle mechanisms with individualized air pressure adjustment, the invention enables the creation of complex mooncake designs with fortified ingredients while ensuring precise control and consistency throughout the printing process. This advancement in real-time printing technology contributes to streamlining mooncake production, offering a more efficient and effective approach than conventional methods. Incorporating multi-nozzle mechanisms with individualized air pressure adjustment in the proposed invention offers several advantages, including higher print resolution, enhanced print speed, flow rate control, and improved consistency.

Another solution provided by the present invention includes a method and system for utilizing AI algorithms to generate unique and aesthetically pleasing patterns explicitly designed on commercial cookies as laser-induced caramel interaction. In the present invention, a novel method and system are introduced for utilizing AI algorithms to generate unique and visually appealing patterns specifically designed for scanning on commercial cookies.

Traditionally, cookie decoration involves time-consuming manual techniques that limit the variety of available designs. Creating intricate patterns on cookies requires skilled artisans and lacks consistency across large batches of cookies. To address these challenges, the present invention leverages the power of AI algorithms and advanced scanning technology to produce fully customizable and generative 2D patterns on cookies via a unique method using a laser. By integrating AI algorithms into the scanning process, a wide range of artistic and personalized designs are generated, enhancing the visual appeal of the cookies. Unlike conventional methods that offer limited or preset patterns, the proposed AI-powered scanning system generates entirely distinct patterns for each cookie. This mass customization capability allows for an infinite array of designs.

The provided methodology incorporates state-of-the-art laser scanning technology to achieve consistent and intricate patterns. High-precision laser systems meticulously etch the patterns onto each cookie, surpassing the capabilities of traditional manual methods and avoiding the use of additional ink as additives. This ensures the engraved designs are precisely replicated, resulting in impeccable and visually appealing cookies with enhanced flavor, texture, and browning effects.

In accordance with a first aspect of the present invention, a system is provided for utilizing AI models to generate pattern or images on a surface of a mooncake. The system includes a user interface (UI) module, an AI-based image module, an image-transformer module, a 3D printer, and a laser patterning module. The UI module serves as an entry component for the system and is configured to facilitate user interaction and input for image generation and to allow a user to enter keywords and descriptions for define an image for a mooncake. The AI-based image module is connected to the UI module and is configured to generates at least one black and white vector-style image based on user's input fed by the UI module. The image-transformer module is connected with the UI module and the AI-based image module and is configured to process a two-dimension pattern or image generated by the AI-based image module, so as to enable three-dimension printing extrusion, determining a desired volume with millimetre resolution to accurately translate patterns into a three-dimension structure for the mooncake. The 3D printer is connected to the image-transformer module and receives the digital instructions from the image-transformer module for 3D printing, in which the 3D printer is configured to form an outer layer, an inner filling, and a top layer for the mooncake using different food ingredients. The laser patterning module is connected to the image-transformer module and receives the digital instructions from the image-transformer module for laser patterning. The laser patterning module is configured to emit a laser beam to a surface of the top layer of the mooncake to create an image or a pattern on the surface of the top layer of the mooncake, involving selectively heating and browning the surface according to the two-dimension pattern or image generated by the AI-based image module which resulting from the user's input.

In accordance with a second aspect of the present invention, a system is provided for utilizing AI models to generate pattern or images on a surface of a cookie. The system includes a UI module, an AI-based image module, an image-transformer module, and a laser patterning module. The UI module serves as an entry component for the system and is configured to facilitate user interaction and input for image generation and to allow a user to enter keywords and descriptions for define an image for a cookie. The AI-based image module is connected to the UI module and is configured to generates at least one black and white vector-style image based on user's input fed by the UI module. The image-transformer module is connected with the UI module and the AI-based image module and is configured to process a two-dimension pattern or image generated by the AI-based image module, so as to format the two-dimension pattern or image into a scalable vector graphics (SVG) file. The laser patterning module is connected to the image-transformer module and receives the digital instructions from the image-transformer module for laser patterning. The laser patterning module is configured to follow a path defined in the SVG file fed by the image-transformer module and engrave a pattern or image design onto a surface of the cookie, so as to cause localized caramelization of the cookie's surface, adding depth and contrast to the cookie's surface.

In accordance with a third aspect of the present invention, a method is provided for utilizing AI models to generate pattern or images on a surface of a pastry. The method includes steps as follows: providing a UI module for serving as an entry component for a user; allowing, by the UI module, the user to enter keywords and descriptions for define an image for a pastry; facilitating, by the UI module, user interaction and input for image generation; generating, by an AI-based image module, at least one black and white vector-style image based on user's input fed by the UI module; processing, by an image-transformer module, a two-dimension pattern or image generated by the AI-based image module, for generating digital instructions at least for a laser patterning module; receiving, by a laser patterning module, the digital instructions from the image-transformer module for laser patterning; and emitting, by the laser patterning module, a laser beam to a surface of the pastry to create an image or a pattern on the surface of the pastry according to the two-dimension pattern or image generated by the AI-based image module which resulting from the user's input.

By the above configuration, AI algorithms are utilized to generate unique and aesthetically pleasing patterns tailored for extrusion and 3D printing on fortified mooncakes. The AI-generated patterns enhance the visual appeal of personalized mooncakes and contribute to the fortification and nutritional aspects of the pastry. The proposed solution also includes incorporating multi-nozzle mechanisms with individualized air pressure adjustment. The proposed solution enables the creation of complex mooncake designs with fortified ingredients while ensuring precise control and consistency throughout the printing process. This advancement in real-time printing technology contributes to streamlining mooncake production, offering a more efficient and effective approach than conventional methods. Incorporating multi-nozzle mechanisms with individualized air pressure adjustment in the proposed solution offers several advantages, including higher print resolution, enhanced print speed, flow rate control, and improved consistency. Further, the novel approach introduced in this disclosure addresses the issue regarding pattern designing of users by incorporating user-friendly features in user interfaces. Instead of requiring users to manually draw or design patterns, the system allows them to input keywords or images as references. The AI algorithms integrated into the system then analyze these inputs and generate appropriate file formats for scanning onto cookies.

### BRIEF DESCRIPTION OF DRAWINGS

Embodiments of the invention are described in more details hereinafter with reference to the drawings, in which:

FIG. 1 depicts a block diagram for a system for utilizing AI algorithms to generate unique and aesthetically pleasing patterns designed explicitly for multi-material extrusion and 3D printing on fortified mooncakes according to some embodiments of the present invention

FIG. 2 depicts a flowchart of a method for a 3D printed mooncake procedure according to some embodiment of the present invention;

FIG. 3 depicts a flowchart of steps S10, S20, and S30 of a method for a 3D printed mooncake procedure according to some embodiment of the present invention;

FIG. 4A depicts a 3D printer designed with multi-nozzle material extrusion according to some embodiments of the present invention;

FIG. 4B depicts a multi-nozzle head system for extruding up to four materials from extrusion syringes according to some embodiments of the present invention;

FIG. 5 depicts a schematic diagram for a 3D-printed mooncake with an AI-generated image being laser patterned on the top layer using the laser patterning module according to some embodiments of the present invention;

FIG. 6 depicts a schematic diagram for an example of a 3D-printed mooncake with an AI-generated image pattern extruded on a top layer;

FIG. 7 depicts a block diagram for a system for utilizing AI algorithms to generate patterns or images on cookies as laser-induced caramel interaction according to some embodiments of the present invention;

FIG. 8 depicts a flowchart of a method for an AI-generated image generation process according to some embodiment of the present invention;

FIG. 9 depicts an example of a set of AI-generated images based on input keywords on Python-based software using the method according to some embodiment of the present invention;

FIG. 10 depicts a flowchart of a method for a fabrication process and caramelizing effect using the laser patterning module according to some embodiment of the present invention;

FIG. 11 depicts a schematic diagram for an example of a cookie with an AI-generated image being laser patterned according to some embodiments of the present invention;

FIG. 12 shows a block diagram illustrating the cookie's sugar laser-induced caramelization process according to some embodiments of the present invention; and

FIG. 13 depicts an example of a cookie with an AI-generated image pattern scanning at different powers according to some embodiments of the present invention.

### DETAILED DESCRIPTION OF THE INVENTION

In the following description, systems and methods for AI-generated patterns integrating multi-food material extrusion, 3D printing, laser applications, and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In this disclosure, the term “connected” encompasses both wired and wireless communication connections, facilitating the transfer or exchange of data or signals. For instance, if element A is described as being connected to element B, it signifies that element A can communicate with element B, enabling the exchange of data or signals.

This disclosure relates to a method for achieving customized patterns on processed food and a system for operating the method. To facilitate understanding, the following content is divided into two parts. The first part applies the technical solution provided by the present invention to mooncakes, while the second part applies the technical solution provided by the present invention to cookies.

### The First Part: A Method and System for Utilizing AI Algorithms to Generate Unique and Aesthetically Pleasing Patterns Designed Explicitly for Multi-Material Extrusion and 3D Printing on Fortified Mooncakes.

The present invention relates to an AI-generated pattern for extrusion and 3D printing on fortified mooncakes with a multi-nozzle air-pressure driven extrusion system. Mooncakes, traditional Chinese pastries consumed during the Mid-Autumn Festival, are known for their intricate designs imprinted on the pastry surface. This invention introduces a novel method of utilizing AI algorithms and a multi-material extrusion method to generate unique and aesthetically pleasing patterns specifically tailored for extrusion and 3D printing on fortified mooncakes. The AI-generated patterns enhance the visual appeal of mooncakes and contribute to the fortification and nutritional aspects of the pastry.

Consistency and mass customization are two significant challenges in traditional food production, including mooncake-making. In the traditional process of creating mooncakes, manpower is required to mold the pastries into specific shapes using molds manually. This process is time-consuming and limits the variety of available patterns, designs, and recipe creation.

Another challenge in traditional mooncake production is meeting personalized nutrition requirements. Traditional mooncakes are typically made with standard ingredients and recipes, offering limited control over the nutritional composition of the pastries. This poses challenges for individuals with specific dietary needs or health concerns. Mooncakes are often associated with high sugar, high-fat content, and calorie-dense fillings, contributing to health risks such as obesity, diabetes, and cardiovascular diseases. The average adult's daily consumption of mooncakes is typically limited due to these health concerns and the need to maintain a balanced diet.

On the other hand, 3D food printing, including the proposed extrusion and 3D printing method for mooncakes, offers the advantages of consistency and mass customization. With 3D food printing technology, mooncakes can be produced more automated and controlled, ensuring consistent shapes, nutritional content, ingredient compositions, sizes, and patterns for each pastry. Incorporating 3D printing technology also eliminates the need for manual, labor-intensive processes like molding, reducing production time and costs. Mooncakes can be produced more efficiently and in larger quantities, meeting the demands of mass production while maintaining consistency in shape and appearance.

Although 3D food printing can be a solution to create personalized food with fortified nutrition, meal preparation for 3D printing often requires technical skills in computer 3D modeling, which can act as a barrier for individuals who wish to create their customized food shapes and appearances. Moreover, 3D food printing involves multiple stages, including recipe creation, 3D modeling, slicing the model into a layer-by-layer fashion, and generating the corresponding G-code instructions for the printer. Each stage typically relies on different software systems, making integration and seamless customization challenging and time-consuming.

Furthermore, printing food items like mooncakes with embedded multiple ingredients poses a significant challenge due to the limitations of current 3D printing technologies. One of the primary issues is the printability of different materials with varying properties. Each ingredient may have distinct viscosity, flow characteristics, and temperature requirements, making it difficult to extrude them consistently through a single printing nozzle. Switching between syringes or printing nozzles to accommodate various ingredients is time-consuming and inefficient. It interrupts the printing workflow and prolongs the overall production time, which may further increase the risk of food contamination from the environment. While dual-material printing technologies are available in the market, they are generally limited to printing with only two materials, which falls short when multiple ingredients must be embedded in a single food item.

Given the abovementioned problems, the proposed method utilizes the AI-generated patterns in the 3D food printing process for extrusion and laser patterning applications to enable a wide range of customizable mooncake designs. The AI algorithm can generate intricate and unique patterns that can be applied to the surface of the mooncakes during the printing process. This allows for mass customization, as each mooncake can have a distinct and personalized design, catering to individual preferences or specific occasions. The present invention incorporates AI to simplify the creation process and reduce the technical expertise required. By leveraging well-established AI text-to-image or image-to-image models implemented in Python-based software, the invention enables users to input positive and negative keywords that define the desired aesthetics and characteristics of the food shape. These keywords act as criteria for the AI algorithm to generate vector-style images, which can then be transformed into extrusion patterns suitable for 3D printing.

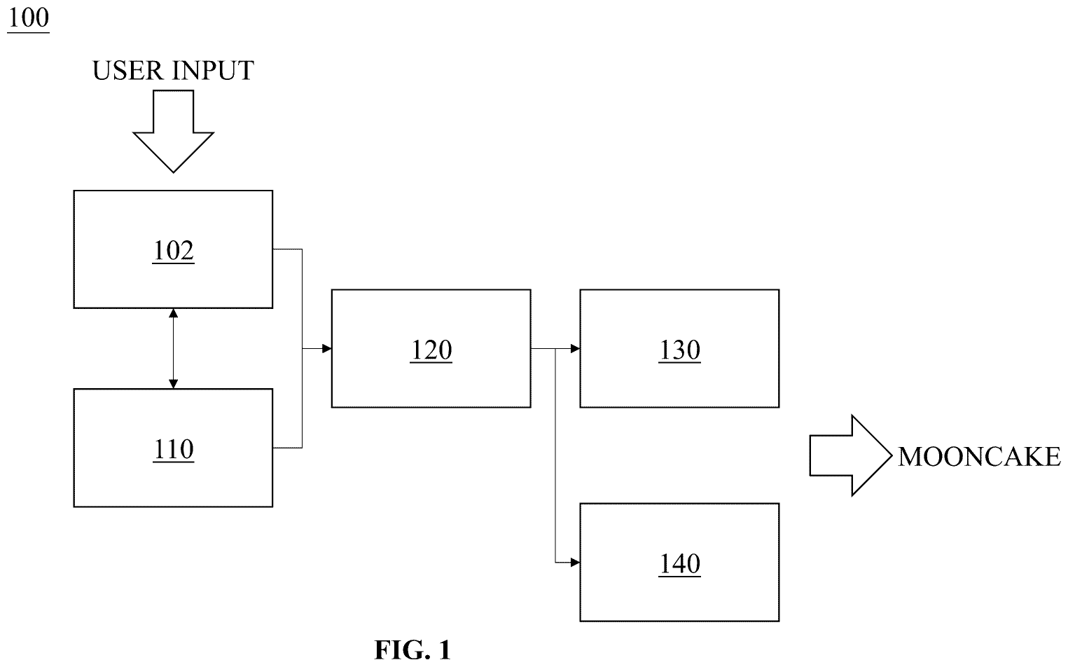

FIG. 1 depicts a block diagram for a system 100 for utilizing AI algorithms to generate unique and aesthetically pleasing patterns designed explicitly for multi-material extrusion and 3D printing on fortified mooncakes according to some embodiments of the present invention. The system 100 includes a user interface (UI) module 102, an AI-based image module 110, an image-transformer module 120, a 3D printer 130, and a laser patterning module 140

The UI module 102 serves as an entry component for system 100, configured to facilitate user interaction and input for the mooncake design process. The UI module 102 provides a dedicated input screen (e.g., a virtual screen) that users can enter keywords and descriptions (i.e., prompts) that define the desired aesthetics and characteristics of the mooncake design. These inputs serve as criteria for the AI algorithm, guiding it to generate customized patterns or images.

The UI module 102 is connected to the AI-based image module 110, which generates black and white vector-style images based on the user's input. In one embodiment, the AI-based image module 110 is implemented in a Python-based engine. After inputting the prompts, users can preview the AI-generated images produced by the AI-based image module 110, allowing for interactive adjustments and real-time feedback to fine-tune their designs. The AI-based image module 110 offers designs tailored to the user's requirements. For example, users can save and edit their design sessions in the AI-based image module 110, providing flexibility and convenience. Once satisfied with the previewed design, users can confirm their selection in the AI-based image module 110, and the finalized design is sent to the next stage for further processing.

As such, the UI module 102 in combination with the AI-based image module 110 simplifies the design process and enhances creativity and customization, enabling users to create unique and personalized mooncakes with ease.

The image-transformer module 120 is connected with the UI module 102 and the AI-based image module 110, and the image-transformer module 120 acts as an intermediary component between a user terminal and a 3D-printer terminal, facilitating the transformation of confirmed 2D patterns or images by the user into 3D printable formats for the 3D printer. The image-transformer module 120 processes the 2D patterns or images generated by the AI-based image module 110 to enable 3D printing extrusion, determining the desired volume with millimetre resolution to accurately translate patterns into 3D structures. Furthermore, the image-transformer module 120 converts the 2D patterns or images into G-code instructions, defining the specific movements and actions of the 3D printer, including the extrusion path and layering of the printed material.

The 3D printer 130 is connected to the image-transformer module 120 and receives digital instructions from it for 3D printing. Equipped with a multi-nozzle material extrusion system and a multi-nozzle head system, the 3D printer 130 can extrude up to four materials from extrusion syringes. The 3D printer 130 is configured to handle different food ingredients with unique viscosity and rheological properties, selecting ingredients for the outer layer and inner filling, including fortified nutrients. During the mooncake fabrication process, the printer first extrudes the outer layer of the mooncake. The 3D printer 130 then uses specific syringe nozzles or combinations to deposit the inner filling, which is enriched with nutrients for added nutritional value. Finally, the 3D printer 130 extrudes the top layer on the outer layer using the AI-generated pattern or image created by the AI-based image module 110, enhancing the visual appeal and incorporating the unique design elements generated by the AI algorithm.

In some embodiments, the image-transformer module 120 further includes a database that stores the dimensions of the mooncake's top layer, outer layer, and inner filling. The database works in conjunction with the digital instructions from the image-transformer module 120 to facilitate the generation of various parameters needed for mooncake production. By integrating these dimensions, the image-transformer module 120 can accurately produce the customized patterns or images on the mooncakes and structures of the mooncakes, ensuring precise and consistent fabrication of each component.

The laser patterning module 140 is connected to the image-transformer module 120 and receives digital instructions from it for laser patterning. The laser patterning module 140 enhances mooncakes (e.g., enhancement to the appearance thereof) produced by the 3D printer 130 by applying intricate patterns generated through the UI module 102. After the top layer of the mooncake is extruded, the module uses a laser to create a detailed pattern on the surface of the mooncake. In one embodiment, this step is optional and it involves selectively heating and browning the surface according to the AI-generated design, which enhances the visual appeal and adds a distinctive aesthetic touch. By reproducing the user-defined patterns, the laser patterning module 140 can further personalize and refine the final appearance for the mooncake.

Accordingly, by the configuration above, a final produce is a personalized mooncake featuring a multi-layered composition. The mooncake includes an outer layer and an inner filling enriched with nutrients, with the top layer showcasing intricate AI-generated patterns. Optionally, the mooncake may also have a laser-patterned browning effect that adds an additional layer of visual appeal.

Further details are given as follows.

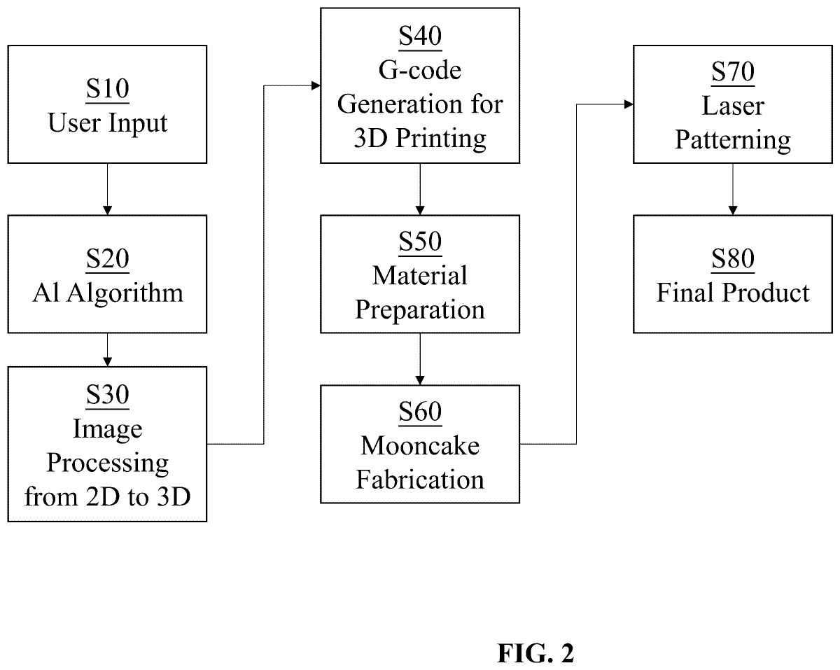

FIG. 2 depicts a flowchart of a method for a 3D printed mooncake procedure according to some embodiment of the present invention. The method, called creating a 3D-printed mooncake with an AI-generated image pattern extrusion, includes steps S10, S20, S30, S40, S50, S60, S70, and S80 in sequence.

The step S10 is user input. In this stage, the user provides input via the UI module 102 to define the desired aesthetics and characteristics of the mooncake design via the AI-based image module 110. The keywords of the input by the user act as criteria for the AI algorithm. The step S20 is AI algorithm. The AI-based image module 110 can generate black and white vector-style images based on the user's input. The step S30 is image processing from 2D to 3D. The generated two-dimensional patterns or images undergo further processing to enable 3D printing extrusion via the image-transformer module 120. In this stage, the desired volume with millimetres resolution is determined.

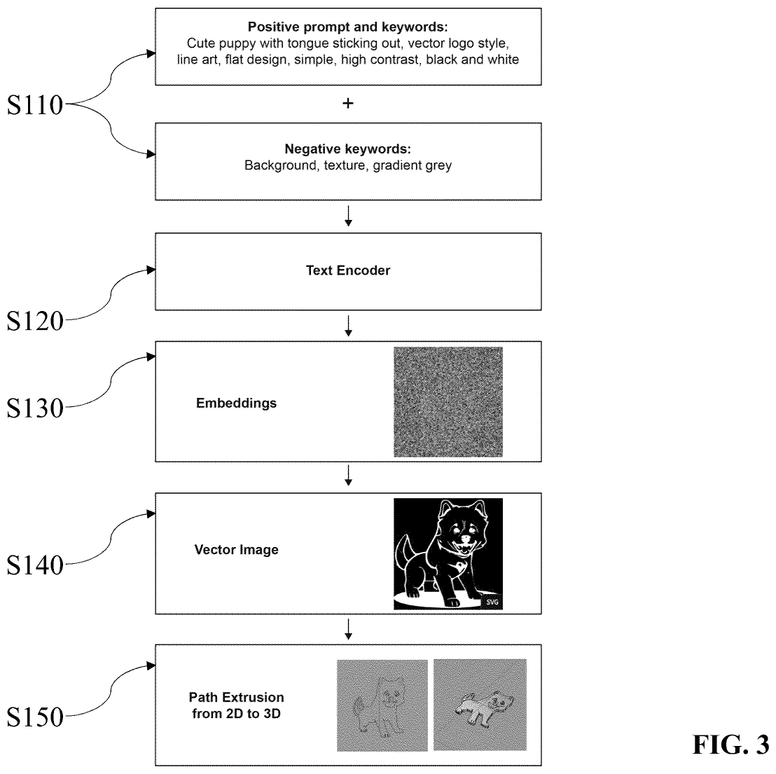

FIG. 3 depicts a flowchart of steps S10, S20, and S30 of a method for a 3D printed mooncake procedure according to some embodiment of the present invention. The illustration of FIG. 3 shows details of steps S10-S30 with an example of a flowchart of a 3D printed moon cake with an AI-generated image pattern extrusion. This co-stage involves steps S110, S120, S130, S140, and S150.

In step S110, the user provides input via the UI module 102. The input includes positive prompt and keywords and negative keywords. In an example of the illustration of FIG. 3, the positive prompt and keywords include: cute puppy with tongue sticking out, vector logo style, line art, flat design, simple, high contrast, black and white; and the negative keywords include: background, texture, gradient grey. The AI-based image module 110 may further include a text encoder for processing the keywords and an embedding layer for transforming these keywords into vector representations suitable for generating patterns or images. As such, in step S120 and S130 of creating a 3D-printed mooncake with an AI-generated image pattern extrusion, the AI-based image module 110 first processes the user prompts by filtering out negative words, generating embeddings, and creating vector image as shown in step S140. In step S150, the processed image are then sent to the image-transformer module 120, which transforms the 2D patterns into 3D formats through path extrusion. This conversion enables the 3D printer 130 to accurately reproduce the AI-generated design in the final mooncake, incorporating detailed and customized patterns into the production process.

Referring back to FIG. 2, the step S40 is G-code Generation for 3D Printing. The 2D patterns are converted into G-code instructions via the image-transformer module 120, which can define the specific movements and actions of the 3D printer 130, including the extrusion path and layering of the printed material. The step S50 is Material Preparation. Different food ingredients with unique viscosity and rheological properties are prepared for printing. Ingredients for the outer layer and inner filling, including fortified nutrients, are selected. The step S60 is Mooncake Fabrication, including an outer layer, an inner layer, and a top layer. At the stage for making the outer layer, the 3D printer 130 begins the fabrication process by extruding the outer layer of the mooncake. At the stage for making the inner layer, the 3D printer 130 uses a specific syringe nozzle or nozzle combination to deposit the inner filling of the mooncake. The inner filling contains fortified nutrients, providing added nutritional value to the mooncake. At the stage for making the top layer, the 3D printer 130 completes the mooncake fabrication by extruding the top layer on the outer layer using the AI-generated pattern. This layer adds visual appeal and incorporates the specific design elements generated by the AI algorithm as afore-described.

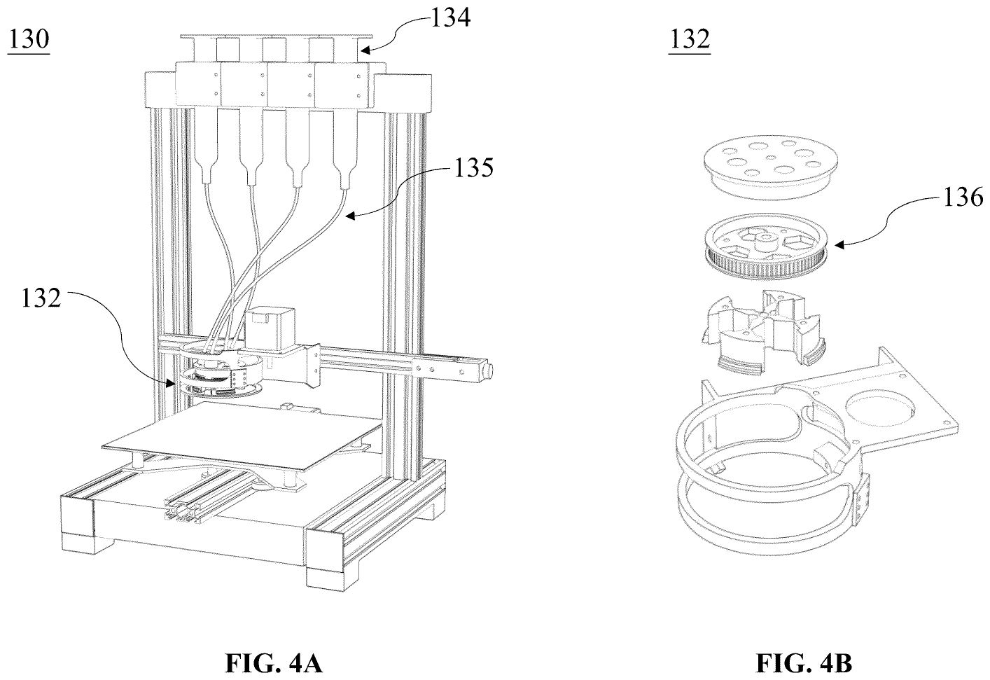

In this regard, FIG. 4A depicts a 3D printer 130 designed with multi-nozzle material extrusion according to some embodiments of the present invention, and FIG. 4B depicts a multi-nozzle head system 132 for extruding up to four materials from extrusion syringes according to some embodiments of the present invention. The 3D printer 130 is equipped with four material storage slots 134, each configured to store a different material or ingredient. The materials for the mooncakes are transported through dedicated pipelines 135 from the material storage slots 134 to the multi-nozzle head system 132. The multi-nozzle head system 132 is connected to four nozzle heads, each capable of extruding a different material. The multi-nozzle head system 132 works in conjunction with a rotating platform 136 to apply various materials or ingredients to the target mooncake, enabling the creation of intricate and multi-layered designs with a high degree of customization.

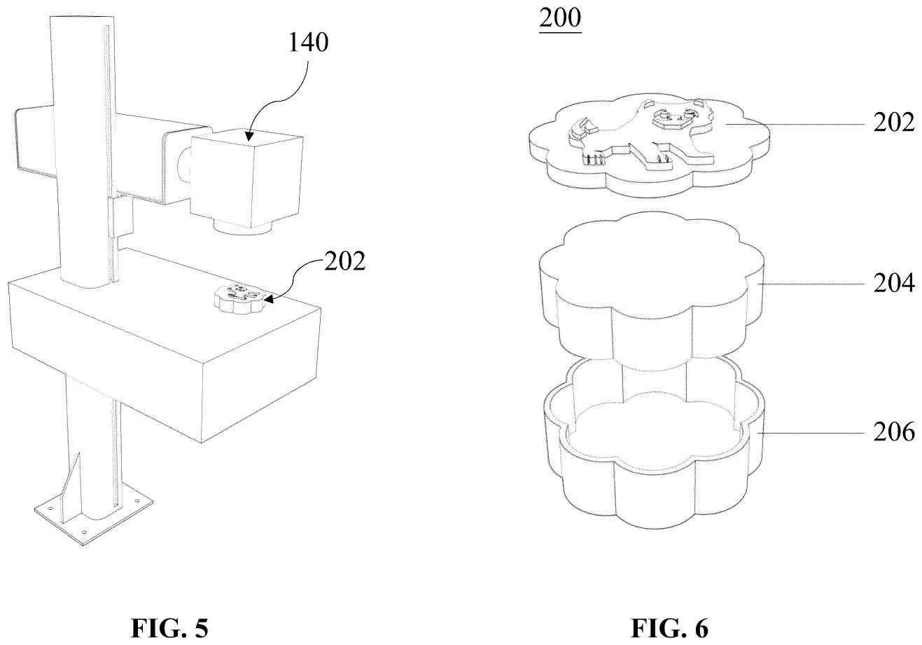

Referring back to FIG. 2, the step S70 is Laser Patterning. After the top layer of the mooncake is extruded, an optional step involves using a laser to create a browning effect on the AI pattern outline. The laser selectively heats and browns the surface of the top layer of the mooncake, enhancing the aesthetic appeal of the design. For example, FIG. 5 depicts a schematic diagram for a 3D-printed mooncake with an AI-generated image being laser patterned on the top layer 202 using the laser patterning module 140 according to some embodiments of the present invention.

The step S70 is obtaining Final Product as FIG. 6 which depicts a schematic diagram for an example of a 3D-printed mooncake 200 with an AI-generated image pattern extruded on a top layer 202. Specifically, the 3D-printed mooncake 200 includes a top layer 202, an inner filing 204, and an outer layer 206.

Regarding the top layer 202, the 3D printer completes the mooncake fabrication by extruding the top layer 202 on the outer layer 206 using the AI-generated pattern or image. The top layer 202 adds visual appeal for the mooncake 200 and incorporates the unique design elements generated by the AI algorithm. Regarding the inner filling 204, the 3D printer uses a specific syringe nozzle or nozzle combination to deposit the inner filling 204 of the mooncake 200. The inner filling 204 contains fortified nutrients, providing added nutritional value to the mooncake. Regarding the outer layer 206, the 3D printer begins the fabrication process by extruding the outer layer 206 of the mooncake 200.

In one embodiment for a practical example, a mooncake can be made according to the following recipe:

The ingredients for the outer layer include: inverted sugar syrup, vegetable oil, lye water, water, and soft wheat flour. The filling with fortified nutrients includes: salted duck egg yolk, whey powder, xanthan gum, water, vegetable oil, turmeric powder. The detailed preparation and post processing procedures for the 3D printing process includes: 1) preheating the 3D printer's heated bed to 100° C.; 2) mixing inverted sugar syrup, lye water, water and vegetable oil in a large mixing bowl until well incorporated; 3) adding soft wheat flour and turmeric powder to the above mixture and mix all ingredients for 5 minutes; 4) covering with plastic wrap and rest for 30 minutes; 5) filling the syringes with the mixed samples separately; 6) printing the mooncake at 100° C. according to the designed procedure utilizing three different 3D modelling files (i.e., outer layer, filling, and top layer); 7) removing the printed sample and bake in the oven at 175° C. for 10 minutes.

By this way, the result for the final product is a personalized mooncake with an outer layer, inner filling fortified with nutrients, a top layer featuring the AI-generated pattern extrusion, and optionally, a laser-patterned browning effect. In the present invention, the method can offer enhanced customization, nutritional fortification, and aesthetic appeal compared to traditional mooncake production methods.

As discussed above, a method and system for utilizing AI algorithms to generate unique patterns designed explicitly for multi-material extrusion and 3D printing on fortified mooncakes are provided. The invention introduces an innovative real-time 4-nozzle material switching mode throughout the process. This mode allows for the mixing and dividing of different layers with distinct food ingredients based on the generated extrusion pattern. By dynamically switching between nozzles, the printer can seamlessly print different food formulas while adhering to the specified pattern, creating visually appealing and customized food shapes with varying flavors and textures.

The proposed solution for the 3D food printing addresses the technical barriers, time-consuming processes, and limited customization options associated with traditional mooncake production. By integrating AI and advanced 3D printing techniques, how mooncakes are created is revolutionize, offering numerous benefits and opportunities. The proposed solution of the present invention eliminates the need for extensive technical skills in computer 3D modeling, making it accessible to individuals who want to create unique food shapes and appearances. The AI-guided process simplifies recipe creation, 3D modeling, slicing, and G-code generation, streamlining the production workflow.

Additionally, the proposed solution of the present invention addresses the challenge of embedding multiple ingredients in a single food item. By implementing multi-nozzle or multi-extruder systems, we enable the simultaneous extrusion of different materials, allowing for intricate and complex mooncakes with various embedded components. This advancement overcomes the limitations of current technologies and provides greater versatility in ingredient selection and design.

The proposed solution of the present invention makes mooncake production more efficient, consistent, and customizable. Individuals are empowered to unleash their creativity, explore new flavors and designs, and meet personalized nutrition requirements. Moreover, possibilities for broader applications in the culinary world are opened up by the provided 3D food printing technology, revolutionizing how food is created and consumed.

Accordingly, the solution provided by the present invention combines AI, advanced 3D printing techniques, and a focus on personalized nutrition to revolutionize the traditional mooncake production process. By simplifying the creation process, offering mass customization capabilities, and enabling the embedding of multiple ingredients, a new level of creativity, efficiency, and customization is achieved in the production of mooncakes and beyond.

### The Second Part: A Method and System for Utilizing AI Algorithms to Generate Unique and Aesthetically Pleasing Patterns Designed Explicitly on Commercial Cookies as Laser-Induced Caramel Interaction.

In this part, the solution provided by the present invention introduces a novel method and system for utilizing AI algorithms to generate unique and visually appealing patterns designed specifically for scanning on general cookies.

Traditionally, cookie decoration involves time-consuming manual techniques that limit the variety of available designs. Creating intricate patterns on cookies requires skilled artisans and lacks consistency across a large batch of cookies. To address these challenges, the provided solution of the present invention leverages the power of AI algorithms and advanced scanning technology to produce fully customizable and generative 2D patterns on cookies via a unique method using a laser beam. By integrating AI algorithms into the scanning process, a wide range of artistic and personalized designs can be provided, enhancing the visual appeal of the cookies. Unlike conventional methods that offer limited or preset patterns, the proposed AI-powered scanning system generates entirely distinct patterns for each cookie. Both the use of AI algorithms and laser scanning technology converge to customization.

The provided methodology of the present invention incorporates state-of-the-art laser scanning technology to achieve consistent and intricate patterns. High-precision laser systems etch the patterns onto each cookie, surpassing the capabilities of traditional manual methods and avoiding the use of additional ink as additives. This ensures the engraved designs are precisely replicated, resulting in visually appealing cookies with enhanced flavor, texture, and browning effects.

A method and system are provided that harnesses the power of AI algorithms to generate unique and visually appealing patterns specifically designed for scanning on commercial cookies. This innovation offers a fully customizable and generative approach to 2D pattern scanning.

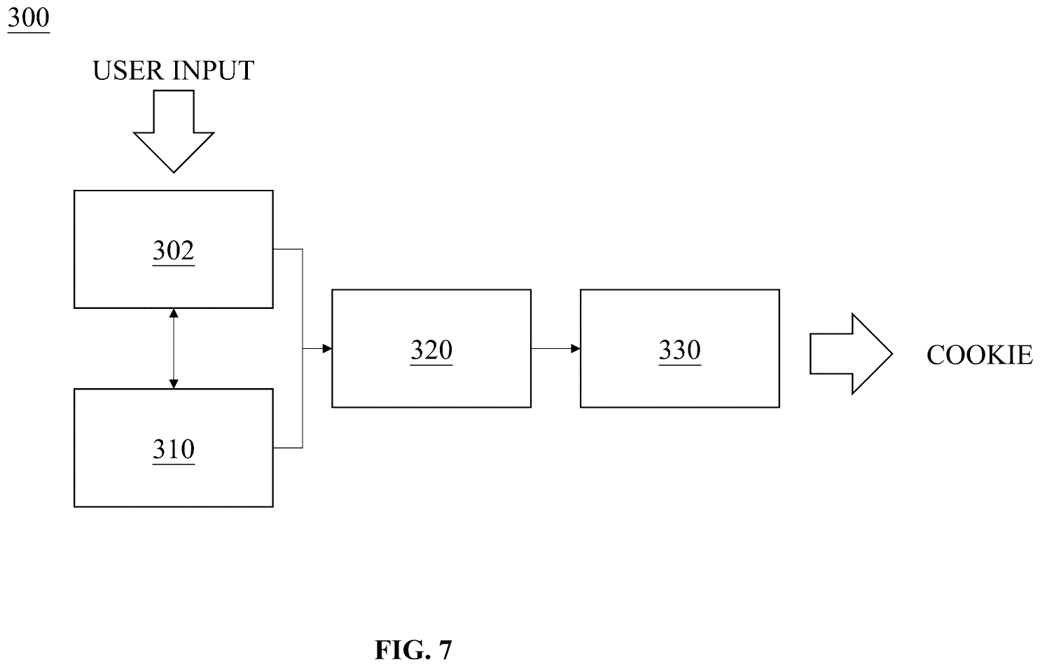

FIG. 7 depicts a block diagram for a system 300 for utilizing AI algorithms to generate patterns or images on cookies as laser-induced caramel interaction according to some embodiments of the present invention. The system 300 has a configuration similar to that of the system 100 as illustrated in FIG. 1, expect the 3D printer 130 of the system 100 is omitted. Specifically, the system 300 is applied to generation of patterns or images on cookies which are formed already. The system 300 includes a UI module 302, an AI-based image module 310, an image-transformer module 320, a laser patterning module 330.

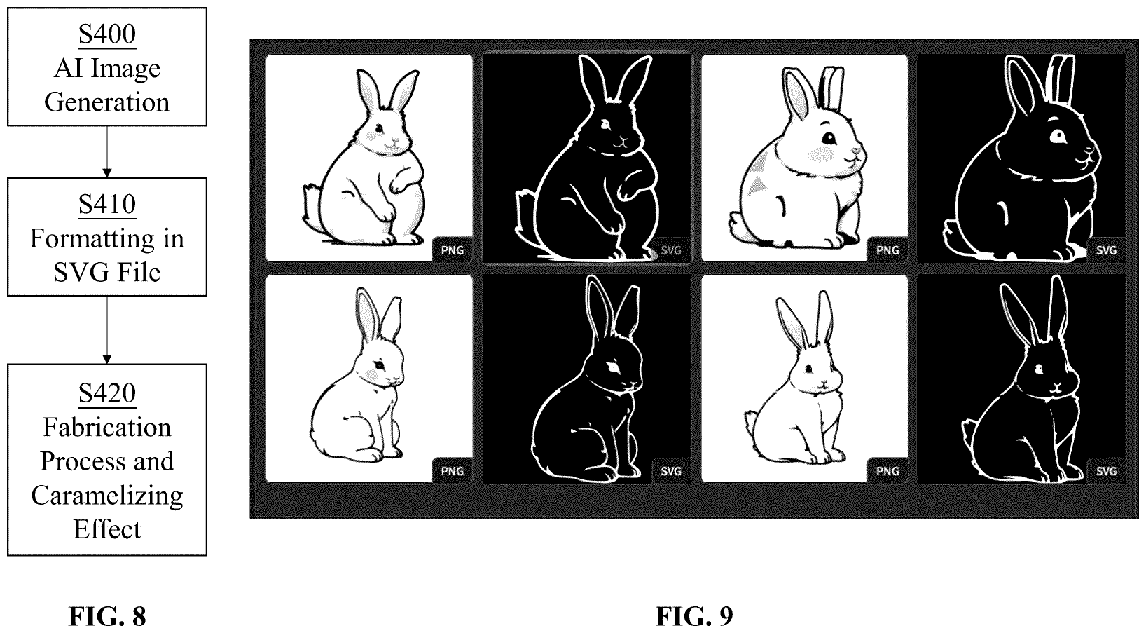

The UI module 302, the AI-based image module 310, and the image-transformer module 320 can collectively work for an AI-generated image generation process. This approach incorporates AI algorithms to simplify the creation process of customized patterns for cookie decoration. FIG. 8 depicts a flowchart of a method for an AI-generated image generation process according to some embodiment of the present invention. The method for an AI-generated image generation process includes steps S400 and S410 in sequence.

Step S400 involves AI Image Generation. As previously described, users may input keywords or image references via the UI module 302. The AI-based image module 310 then generates black-and-white vector-style images. This step involves an input generation stage as well. Users provide positive and negative keywords or upload reference images that define the desired aesthetics and characteristics of the cookie decoration. These inputs act as criteria for the AI algorithm to generate black-and-white vector-style images. In one embodiment, well-established AI text-to-image or image-to-image models of the AI-based image module 310 (e.g., using Python-based model) can analyze the provided keywords or images. The AI algorithm of the AI-based image module 310 then generates two-dimensional patterns based on the inputs, ensuring that each pattern is unique and aligned with the user's preferences.

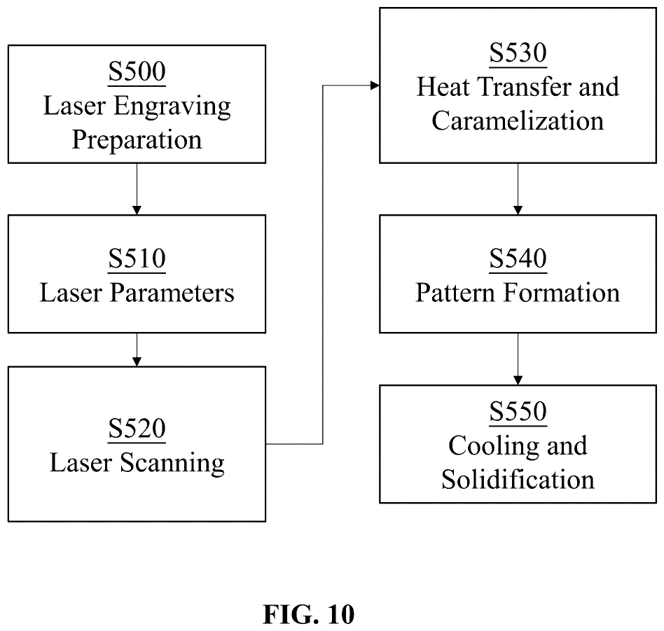

Step S410 involves Formatting in Scalable Vector Graphics (SVG) File. The generated black and white vector-style images by the AI-based image module 310 are then formatted into an SVG file by the image-transformer module 320. The SVG file is a widely used XML-based file format that describes two-dimensional vector graphics. It allows for precise control over the shape, color, and other visual elements of the design. For example, FIG. 9 depicts an example of a set of AI-generated images based on input keywords on Python-based software using the method according to some embodiment of the present invention. This step is called a pattern conversion stage as well. The generated two-dimensional patterns are converted into a format suitable for scanning onto cookies. The conversion process ensures that the patterns are optimized for the cookie decoration process, taking into account factors such as resolution and compatibility with scanning techniques.

The method further includes step S420, which is performed using the laser patterning module 330 collectively.

Step S420 involves Fabrication Process and Caramelizing Effect. The laser patterning module 330 follows the path defined in the SVG file fed by the image-transformer module 320 and engraves the design onto the surface of the cookie. The energy of the laser patterning module 330 is controlled to cause localized caramelization of the cookie's surface, adding depth and contrast to the cookies' surface. This stage may include several steps.

FIG. 10 depicts a flowchart of a method for a fabrication process and caramelizing effect using the laser patterning module 330 according to some embodiment of the present invention. The method for the fabrication process and the caramelizing effect using the laser patterning module 330 includes steps S500, S510, S520, S530, S540, and S550 in sequence.

Step S500 involves Laser Engraving Preparation. This step is called laser scanning reparation as well. Before initiating the laser-induced caramel interaction, the cookie surface is prepared by ensuring it is clean and free from any contaminants. The cookie is positioned securely on the scanning platform of the laser patterning module 330 to maintain stability during the process.

Step S510 involves Laser Parameters. The laser patterning module 330 is set up with specific parameters to achieve the desired caramelization effect. Parameters such as laser power, speed, frequency, and pulse duration are carefully determined based on the cookie's composition and desired outcome. The laser provided by the laser patterning module 330 in this process operates at a wavelength suitable for efficient energy absorption by the cookie surface. In one embodiment, the laser patterning module 330 may further include a controller for storing parameter setting. The stored parameter setting in the controller can be set up before the laser patterning and applied to the laser patterning module 330 when the laser patterning. The Details of the parameters optimization include:
(1): Number of passes: It refers to the number of times the laser beam to scan over the surface of the cookie. In one embodiment, it is set to 1, indicating a single pass.
(2): Speed (mm/s): It specifies the speed at which the laser beam moves across the cookie surface during the engraving process. In one embodiment, a speed of 1000 mm/s is applied and it means the laser beam moves at a rate of 1000 millimeters per second.
(3): Power (%): It determines the intensity of the laser beam. In one
embodiment, the power is represented as a percentage, with 10% indicating that the laser is operating at 10% of its maximum power output.
(4): Frequency (kHz): It refers to the frequency of the laser pulses emitted per second. In one embodiment, a frequency of 30 kHz for the laser is applied and it means that the laser emits 30,000 pulses per second.
(5): Pulse duration: It specifies the duration of each laser pulse. In one embodiment, the pulse duration is set to 10 nanoseconds, indicating that each laser pulse lasts for 10 billionths of a second.
(6): Laser on delay: It represents the delay time before the laser turns on after initiating the engraving process. In one embodiment, a value of 0 means is applied and there is no delay, and the laser turns on immediately.
(7): Laser off delay: It indicates the delay time after the laser finishes engraving before it turns off. In one embodiment, a delay of 100 is applied and it means that the laser remains on for an additional 100 milliseconds after completing the engraving process.
(8): Laser end delay: It represents the delay time after the laser completes each pass before it starts the next pass. In one embodiment, a delay of 50 is applied and it means that there is a pause of 50 milliseconds between passes.
(9): Laser polygon delay: It refers to the delay time between two consecutive points in a polygon during the laser scanning process. In one embodiment, a delay of 80 is applied and it indicates an 80-millisecond pause between points.

These parameters control the behavior of the laser engraving machine, dictating the speed, power, and timing of the laser pulses. By adjusting these parameters, precise and controlled engraving can be achieved, resulting in intricate and visually appealing patterns on the cookie surface.

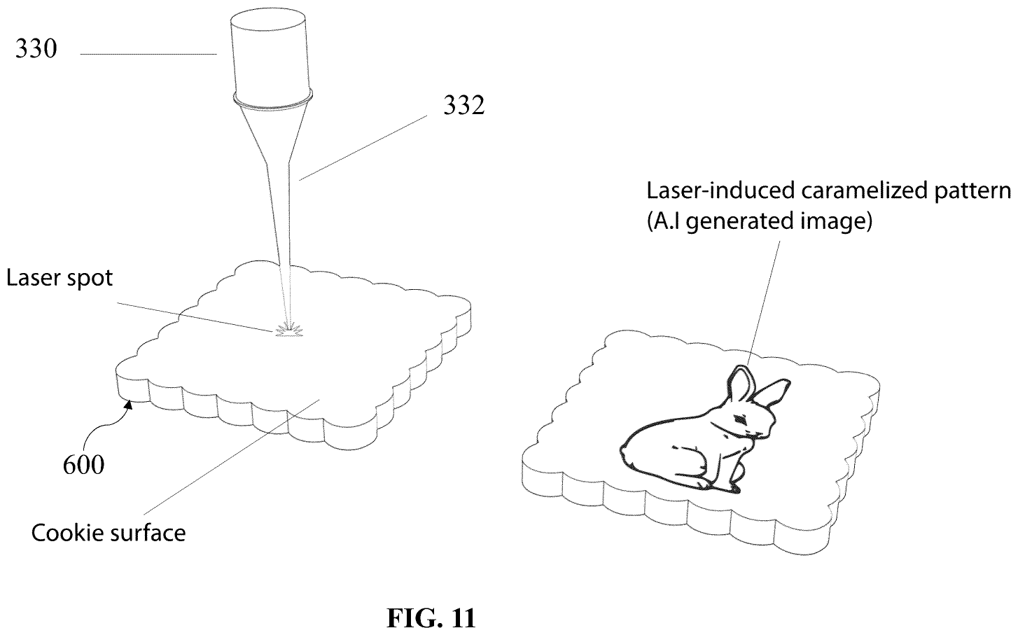

Step S520 involves Laser Scanning. FIG. 11 depicts a schematic diagram for an example of a cookie 600 with an AI-generated image being laser patterned according to some embodiments of the present invention. The converted patterns are engraved onto the cookie 600 using the laser patterning module 330. The laser patterning module 330 providing a laser beam 332 operates at a wavelength of 1066 nm, with a power output set at 10%, a speed of 1000 mm/s, a frequency of 30 kHz, and a pulse duration of 10 nanoseconds. A laser spot on the cookie surface results from the laser beam 332 provided by the laser patterning module 330, thereby forming outline for a desired image (i.e., moving the laser spot and then the image outline completed by the trace of the laser spot).

In one embodiment, the laser patterning module 330 further includes a database that records the dimensions of the cookies to be processed, ensuring that during the laser patterning process, the laser beam does not exceed the size boundaries of the cookies.

These optimized settings ensure scanning of the cookies while maintaining a high resolution. The scanning process is controlled to avoid burning or penetrating the cookies too deeply, resulting in visually appealing and well-defined patterns. In one embodiment, the laser patterning module 330 provides a laser beam and it is directed onto the surface of the cookie in a controlled scanning pattern generated from AI tools (e.g., a controller with a model disposed in the laser patterning module 330), delivering precise and localized bursts of energy.

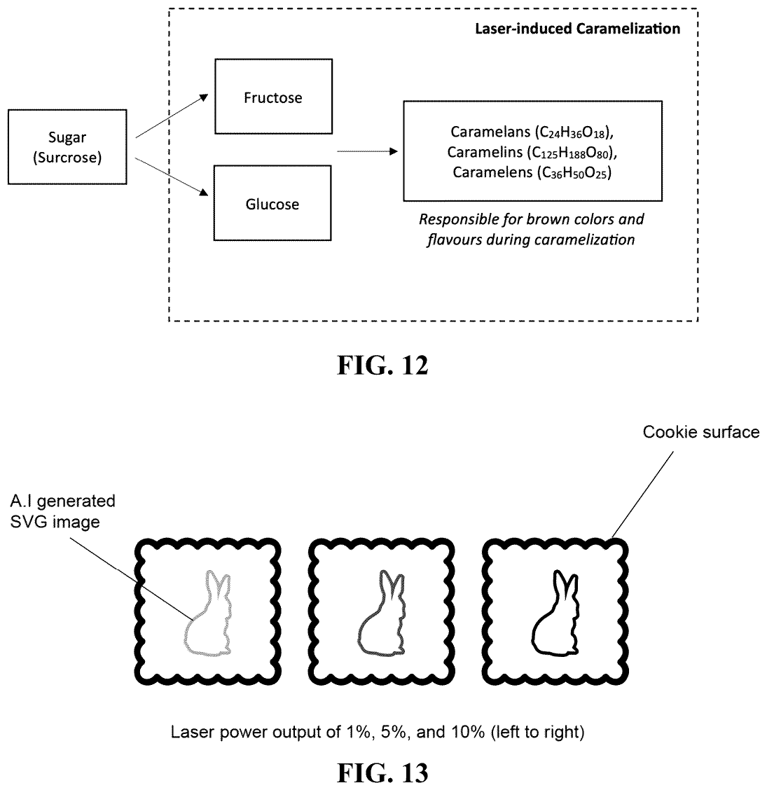

Step S530 involves Heat Transfer and Caramelization. The energy of the laser beam 332 provided by the laser patterning module 330 is controlled to cause localized caramelization of the cookie's surface for the cookie 600, resulting in a visually appealing pattern. The caramelization process adds depth and contrast to the design, enhancing its overall appearance. The laser energy of the laser beam 332 provided by the laser patterning module 330 interacts with the cookie's surface, rapidly heating it. Sugars present in the cookie 600 undergo a caramelization process. The high temperatures achieved by the laser beam 332 cause the sugar molecules to break down and undergo a series of complex chemical reactions, resulting in the formation of caramel compounds. FIG. 12 shows a block diagram illustrating the cookie's sugar laser-induced caramelization process according to some embodiments of the present invention.

Step S540 involves Pattern Formation. The laser scanning process creates a desired pattern or design by selectively caramelizing specific areas of the cookie surface. The intensity and duration of laser exposure determine the depth and darkness of the caramelization. For example, FIG. 13 depicts an example of a cookie with an AI-generated image pattern scanning at different powers according to some embodiments of the present invention.

Step S550 involves Cooling and Solidification. The cookie is allowed to cool, allowing the caramelized areas to solidify to ensure the pattern remains intact.

By following this workflow, users can easily create customized patterns for cookie decoration without the need for manual drawing or design skills. The AI algorithms generate unique designs based on user inputs, and the laser scanning process ensures precise and efficient production of engraved cookies at a high volume. Users can transform their ideas into engraved patterns on cookies, whether it's a personalized message, a specific logo, or a thematic image. Moreover, this workflow is available for batch production. The optimized speed of the laser scanning process allows for efficient batch production of engraved cookies. The system can handle a high volume of cookies while maintaining consistent scanning quality and speed.

Furthermore, the provided approach utilizes the material of the cookie itself to create a caramelized effect instead of adding additional food ink, which may affect the taste and texture of the cookie. By converting the sugar compound in the cookie dough into a caramelized state during the baking process, a decorative effect can be achieved without the need for additional additives or inks. This method offers several advantages. First, it preserves the natural taste and texture of the cookie since no additional ingredients are introduced. The caramelized effect can add a visually appealing and unique touch to the cookies while maintaining their original flavors.

The advantages of the provided solution by the present invention for cookies are summarized as follows:

User-Friendliness: the provided solution by the present invention eliminates the need for manual drawing or design skills, making cookie decoration accessible to individuals without specialized artistic training or expertise.

Customization: users can input keywords or select images to create personalized patterns that align with their desired aesthetics or themes, allowing for a wide range of customization options.

Time-Saving: the streamlined process of generating patterns through AI algorithms and laser scanning reduces the time required to create intricate designs on cookies.

High Resolution: the optimized settings of the laser scanning machine ensure precise scanning on cookies, resulting in visually appealing and well-defined patterns with high resolution.

Efficiency in Batch Production: the provided solution by the present invention offers optimized speed allowing for efficient production of a large volume of engraved cookies, making it suitable for commercial purposes.

Wide Range of Designs: The AI algorithms can generate unique patterns based on user inputs, enabling a diverse range of designs and eliminating the repetition often associated with pre-set pattern scanning machines.

Enhanced Accessibility: the provided solution by the present invention expands the accessibility of cookie decoration to a wider audience, as users do not need extensive artistic training or expertise to create visually appealing patterns.

Versatility: the provided solution by the present invention can be applied to various types of cookies and shapes, allowing for flexibility in the design and decoration process.

Consistent Quality: the precise control provided by the laser scanning process ensures consistent quality across all the engraved cookies, maintaining the integrity and visual appeal of the patterns.

Reduced Ingredient Interference: conversion of the cookie's sugar compound into a caramelized effect eliminates concerns about the taste, texture, and potential allergenic or dietary restrictions associated with additional additives. It allows the natural flavors of the cookies to be preserved.

Enhanced Crispiness and Flavor Release: the laser-induced caramelization creates a delicate and appealing golden brown color, which is associated with a satisfying crunch and texture.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for utilizing AI models to generate pattern or images on a surface of a mooncake, comprising:
a user interface (UI) module serving as an entry component for the system and configured to facilitate user interaction and input for image generation and to allow a user to enter keywords and descriptions for define an image for a mooncake;
an AI-based image module connected to the UI module and configured to generates at least one black and white vector-style image based on user's input fed by the UI module;
an image-transformer module connected with the UI module and the AI-based image module and configured to process a two-dimension pattern or image generated by the AI-based image module, so as to enable three-dimension printing extrusion, determining a desired volume with millimetre resolution to accurately translate patterns into a three-dimension structure for the mooncake;
a 3D printer connected to the image-transformer module and receiving the digital instructions from the image-transformer module for 3D printing, wherein the 3D printer is configured to form an outer layer, an inner filling, and a top layer for the mooncake using different food ingredients; and
a laser patterning module connected to the image-transformer module and receiving the digital instructions from the image-transformer module for laser patterning, wherein the laser patterning module is configured to emit a laser beam to a surface of the top layer of the mooncake to create an image or a pattern on the surface of the top layer of the mooncake, involving selectively heating and browning the surface according to the two-dimension pattern or image generated by the AI-based image module which resulting from the user's input.

2. The system according to claim 1, wherein the UI module is further configured to provide a dedicated input screen for the user, offering an interface for entering positive and negative keywords.

3. The system according to claim 2, wherein the AI-based image module is implemented in a Python-based engine, and wherein the dedicated input screen of the UI module is configured to show an AI-generated image produced by the AI-based image module for the user, allowing for interactive adjustments and real-time feedback to fine-tune images.

4. The system according to claim 1, wherein the image-transformer module is further configured to convert the two-dimension pattern or image generated by the AI-based image module into G-code instructions for the 3D printer for defining specific movements and actions of the 3D printer, including an extrusion path and layering of printed materials.

5. The system according to claim 1, wherein the 3D printer is equipped with a multi-nozzle material extrusion system and a multi-nozzle head system, allowing the 3D printer to extrude up to four materials from extrusion syringes.

6. The system according to claim 5, wherein the 3D printer is equipped with four material storage slots, each configured to store a different material or ingredient, the 3D printer comprises dedicated pipelines for transporting the material or ingredient from material storage slots to the multi-nozzle head system, and wherein the multi-nozzle head system is connected to four nozzle heads, each capable of extruding a different material, and works in conjunction with a rotating platform to apply the materials or ingredients to the mooncake.

7. The system according to claim 1, wherein the image-transformer module further comprises a database configured to store at least one dimensions of the mooncake's top layer, outer layer, and inner filling, and wherein the database works in conjunction with the digital instructions from the image-transformer module to facilitate the image generation of various parameters needed for mooncake production.

8. A system for utilizing AI models to generate pattern or images on a surface of a cookie, comprising:
a user interface (UI) module serving as an entry component for the system and configured to facilitate user interaction and input for image generation and to allow a user to enter keywords and descriptions for define an image for a cookie;
an AI-based image module connected to the UI module and configured to generates at least one black and white vector-style image based on user's input fed by the UI module;
an image-transformer module connected with the UI module and the AI-based image module and configured to process a two-dimension pattern or image generated by the AI-based image module, so as to format the two-dimension pattern or image into a scalable vector graphics (SVG) file; and
a laser patterning module connected to the image-transformer module and receiving the digital instructions from the image-transformer module for laser patterning, wherein the laser patterning module is configured to follow a path defined in the SVG file fed by the image-transformer module and engrave a pattern or image design onto a surface of the cookie, so as to cause localized caramelization of the cookie's surface, adding depth and contrast to the cookie's surface.

9. The system according to claim 8, wherein the laser patterning module further comprises a controller for storing parameter setting, and wherein the parameter setting comprises number of passes, speed, power, frequency, pulse duration, laser on delay, laser off delay, laser end delay, and laser polygon delay.

10. The system according to claim 9, wherein the controller is configured to apply the parameter settings to the laser patterning module, such that the laser patterning module performs the laser patterning with a wavelength of 1066 nm, a power output set at 10%, a speed of 1000 mm/s, a frequency of 30 kHz, and a pulse duration of 10 nanoseconds.

11. The system according to claim 10, wherein the laser patterning module further includes a database that records the dimensions of the cookies to be processed, ensuring that during the laser patterning process, the laser beam does not exceed the size boundaries of the cookies.

12. The system according to claim 8, wherein the AI-based image module further comprises AI text-to-image or image-to-image models using Python-based model for analyzing the keywords and descriptions fed by the UI module.

13. A method for utilizing AI models to generate pattern or images on a surface of a pastry, comprising:
providing a user interface (UI) module for serving as an entry component for a user;
allowing, by the UI module, the user to enter keywords and descriptions for define an image for a pastry;
facilitating, by the UI module, user interaction and input for image generation;
generating, by an AI-based image module, at least one black and white vector-style image based on user's input fed by the UI module;
processing, by an image-transformer module, a two-dimension pattern or image generated by the AI-based image module, for generating digital instructions at least for a laser patterning module;
receiving, by a laser patterning module, the digital instructions from the image-transformer module for laser patterning; and
emitting, by the laser patterning module, a laser beam to a surface of the pastry to create an image or a pattern on the surface of the pastry according to the two-dimension pattern or image generated by the AI-based image module which resulting from the user's input.

14. The method according to claim 13, wherein the pastry is a mooncake, and the method further comprises:
processing the two-dimension pattern or image to enable three-dimension printing extrusion;
determining a desired volume with millimetre resolution to accurately translate patterns into a three-dimension structure for the mooncake;
forming, by a 3D printer, an outer layer, an inner filling, and a top layer for the mooncake using different food ingredients; and
controlling the laser beam for selectively heating and browning the surface of the top layer of the mooncake.

15. The system according to claim 14, further comprising:
showing, by a dedicated input screen, an AI-generated image produced by the AI-based image module for the user, allowing for interactive adjustments and real-time feedback to fine-tune images.

16. The system according to claim 14, further comprising:
extruding, by the 3D printer, up to four materials from extrusion syringes, wherein the 3D printer is equipped with four material storage slots, each configured to store a different material or ingredient, the 3D printer comprises dedicated pipelines for transporting the material or ingredient from the material storage slots to the multi-nozzle head system, and wherein the multi-nozzle head system is connected to four nozzle heads, each capable of extruding a different material, and works in conjunction with a rotating platform to apply the materials or ingredients to the mooncake.

17. The method according to claim 13, wherein the pastry is a cookie, and the method further comprises:
formatting the two-dimension pattern or image into a scalable vector graphics (SVG) file;
controlling the laser beam by having the laser beam follow a path defined in the SVG file; and
engraving, by the laser patterning module, a pattern or image design onto a surface of the cookie, so as to cause localized caramelization of the cookie's surface, adding depth and contrast to the cookies' surface.

18. The method according to claim 17, further comprising:
storing, by a controller, parameter setting for the laser patterning module, wherein the parameter setting comprises number of passes, speed, power, frequency, pulse duration, laser on delay, laser off delay, laser end delay, and laser polygon delay.

19. The method according to claim 18, further comprising:
applying, by the controller, the parameter settings to the laser patterning module, such that the laser patterning module performs the laser patterning with a wavelength of 1066 nm, a power output set at 10%, a speed of 1000 mm/s, a frequency of 30 kHz, and a pulse duration of 10 nanoseconds.
